(19) United States
(12) Patent Application Publication
(10) Pub. No.: US 2002/0121167 A1
(43) Pub. Date: Sep. 5, 2002

(54) Machining method of difficult-to-machine material and machining tool therefor

(76) Inventors: Isamu Yamashita, Ogori-shi (JP); Tsuyoshi Doutsu, Miyaki-gun (JP); Hitoshi Tanaka, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/082,199

(22) Filed: Feb. 26, 2002

(30) Foreign Application Priority Data
Mar. 2, 2001 (JP) 2001-59319

(51) Int. Cl. B23B 1/00

(52) U.S. Cl. 82/1.11; 407/119

(57) ABSTRACT

The invention provides a novel machining tool suitable for machining, e.g., lathing, of a workpiece made from a difficult-to-machine material such as fully sintered ceramics and quench-hardened high-chromium cast irons. The machining tool has a conically pointed cutting chip of a cemented metal carbide and provided with a round-bottom groove of a 0.2-0.5 mm radius of curvature running with an inclination angle of 15-60° relative to the cutting face of the chip. The invention also provides a machining method for a workpiece of a difficult-to-machine material by using the above-mentioned machining tool, in which ultrasonic vibrations are applied to the tool in the cutting direction so that abrasive wearing of the flank surface can be decreased.

### BACKGROUND OF THE INVENTION

The present invention relates to a novel method for machining of a workpiece made from a difficult-to-machine material such as fully sintered ceramics and quench-hardened high-chromium cast irons and also to a novel machining tool used in the method.

Since the hardness of a difficult-to-machine material such as fully sintered ceramic materials and quench-hardened high-chromium cast iron materials is extremely high, machining, e.g., cutting, lathing and drilling, of a workpiece of these materials cannot be conducted without using a diamond tool or CBN (cubic boron nitride) tool. Due to the expensiveness of these machining tools and relatively short durability life thereof resulting in high costs of the machine-worked products, abrasive grinding is heretofore the only practical machining method for these difficult-to-machine materials.

The above-mentioned abrasive grinding method, however, has problems that the machining efficiency is low and that the method is hardly applicable to the works for a complicated form such as grooving and screw-thread cutting so that development of a versatile machining method not relying on grinding is eagerly desired in the machining technology.

### SUMMARY OF THE INVENTION

In view of the above described problems and disadvantages in the conventional machining method of difficult-to-machine materials, the present invention has an object to provide a highly efficient novel method of machining a high-hardness material, which is taken as difficult-to-machine in the prior art, by using a machining tool made from a relatively inexpensive material as well as to provide such a machining tool used in the method.

Thus, the machining method of a workpiece made from a difficult-to-machine material provided by the invention comprises the steps of: putting a cutting tool having a cutting chip of a cemented metal carbide, which is provided with a round-bottom groove as defined below, to the workpiece; and applying ultrasonic vibrations to the cutting chip in the cutting direction.

The machining tool of the present invention for use in the above-defined inventive machining method comprises: a conically pointed chip made from a cemented metal carbide, the conical end portion thereof being provided with a round-bottom groove having a radius of curvature in the range from 0.2 to 0.5 mm and running in a direction inclined by 15 to 60° relative to the cutting face.

### BRIEF DESCRIPTION OF THE DRAWING

FIG. 1 is a schematic illustration of the side view of a machine for practicing the inventive method.

FIGS. 2A, 2B and 2C are each an illustration showing the cutting chip of the inventive machining tool.

FIG. 3 is a perspective view of the cutting chip illustrated in FIGS. 2A to 2C.

FIG. 4 is a graph showing the major flank abrasion of the tool as a function of the work time in Example 1.

FIG. 5 is a graph showing the undeformed chip thickness as a function of the work time in Example 1.

FIG. 6 is a graph showing the cutting force as a function of the work time in Example 2.

FIG. 7 is a graph showing the major flank abrasion as a function of the work time in Example 2.

FIG. 8 is a graph showing the undeformed chip thickness as a function of the work time in Example 2.

### DETAILED DESCRIPTION OF THE PREFERRED EMBODIMENTS

In the following, the present invention is described in detail by making reference to the accompanying drawing.

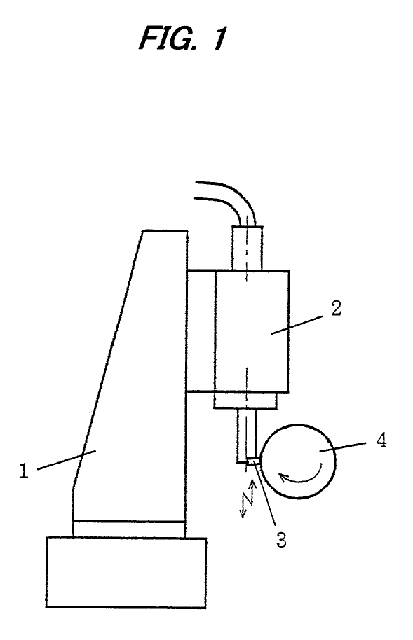

FIG. 1 is a schematic side view of a machining system for practicing the inventive machining method, in which a cutting tool 3 of the invention is mounted on the lower end of the ultrasonic vibrator 2 supported by the support 1 standing on a bed and the cutting tool 3 is put at the workpiece 4 rotating in the direction indicated by the arrow while the cutting tool 3 is under ultrasonic vibrations in the up-to-down direction indicated by the double-sided cranked arrow by operating the ultrasonic vibrator 2.

The frequency of the ultrasonic vibrations here is preferably in the range from 20 kHz to 75 kHz. The cutting tool 3 has a chip made from a cemented metal carbide such as those of tungsten carbide cemented with metallic cobalt and optionally coated by applying the PVD (physical vapor deposition) method. Several grades of coated chips are available as commercial products including KC730 (a product by Kennametal, Inc.) and UP20M (a product by Mitsubishi Material Co.) which can be used in the inventive method advantageously.

The inventive method under ultrasonic vibrations of the tool is applicable to a hardly machinable workpiece for which conventional diamond chip tools can never be used under ultrasonic vibrations due to instantaneous chipping of the diamond chip.

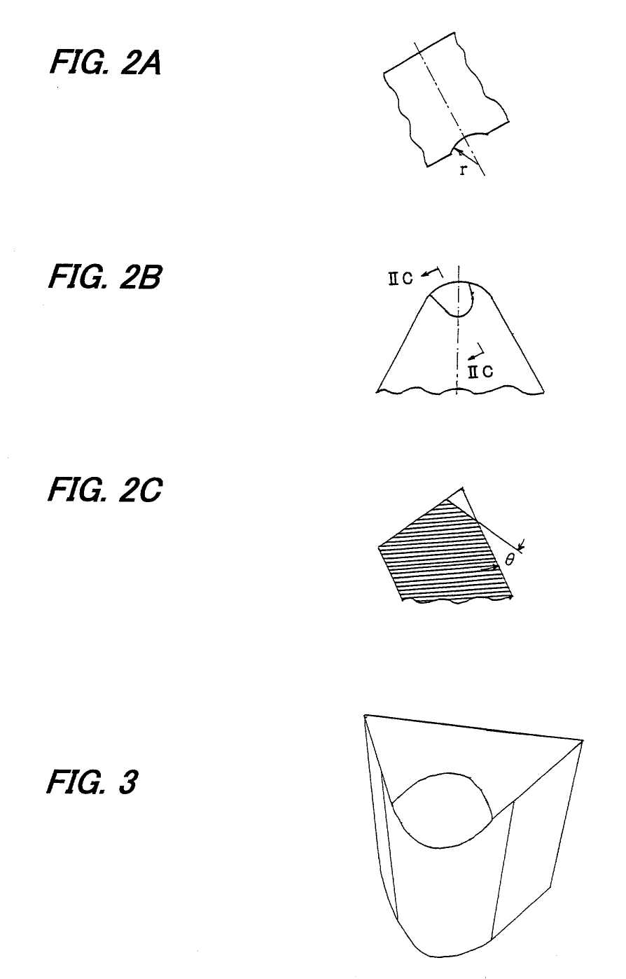

FIGS. 2A, 2B and 2C are each a schematic illustration of the chip portion of the inventive machining tool, of which FIG. 2A is a side elevational view of the chip, FIG. 2B is a plan view of the chip showing the cutting face and FIG. 2C is a cross sectional view of the chip as cut and viewed along the arrows IIC-IIC in FIG. 2B. FIG. 3 is a perspective view of the same chip. As is shown in these figures, the chip is provided with a round-bottom groove having a radius of curvature r, which is preferably 0.2 to 0.5 mm, and running with an inclination angle of θ, which is 15 to 60° or, preferably, 25 to 45°.

Although, needless to say, chips of a cemented metal carbide are very inexpensive as compared with diamond chips, conventional cemented metal carbide chips cannot be used for machining of a difficult-to-machine material such as fully sintered ceramic materials and quench-hardened high-chromium cast iron materials in a conventional working procedure due to great abrasive wearing of the chip resulting in a rapid loss of cutting power within a short time. According to the general understanding in the art, these conventional chips cannot be used also in an ultrasonic vibration-assisted machining work because of instantaneous chipping of the chip.

In contrast thereto, it is a quite unexpected discovery leading to the present invention that the cemented metal carbide chip having the above defined grooved structure is little subject to the chipping damage when used even in machining of a hardly machinable workpiece under ultrasonic vibration assist. The machining conditions in this case are not particularly limitative and can be conventional. Accordingly, the inventive method is industrially very advantageous because hardly machinable workpieces can be worked at a high efficiency by using a very inexpensive tool leading to a great reduction of the costs for the machining works.

In the following, the present invention is described in more detail by way of Examples, which, however, never limit the scope of the invention in any way.

### EXAMPLE 1

The workpiece subjected to a lathing work according to the invention was a sintered zirconia ceramic body having: a density of 5.98 g/cm³; hardness of 91 HRA; bending strength of 1200 MPa; and Young's modulus of 190 GPa. Several cutting chips of a cemented metal carbide were prepared from commercially available chips of KC730 and UP20M (supra) by forming a round-bottom groove according to the invention. The grooves had an angle of inclination θ of 0°, 15°, 30°, 45° or 60° and a radius of curvature r of the round bottom of 0.4 mm in each of the chips. The lathing test of the workpiece was conducted either without or with application of ultrasonic vibrations in a frequency of 40 kHz and with an amplitude of 11 μm as generated by the ultrasonic vibrator equipped in the machine system. The feed rate was 0.033 mm/revolution and the cutting speed was 11 m/minute.

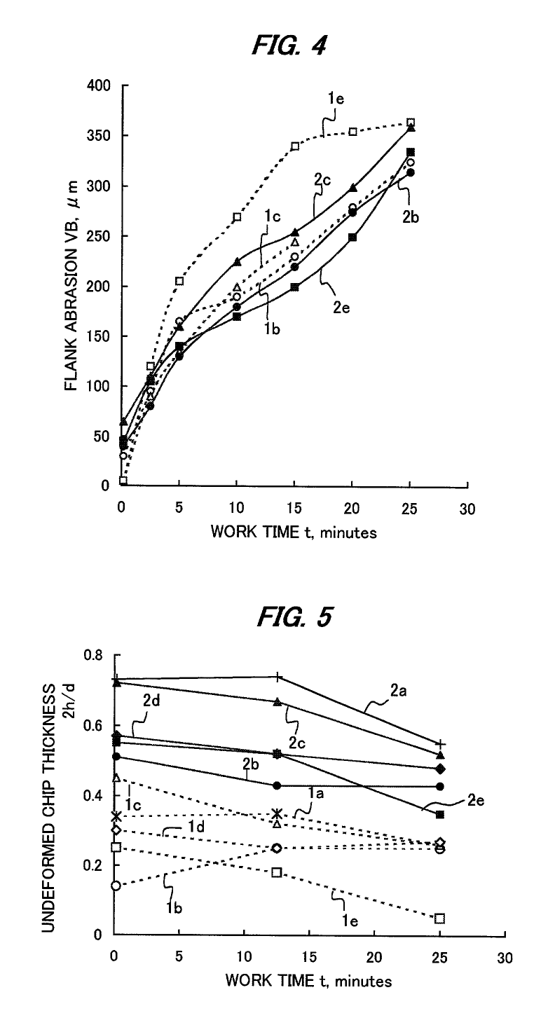

The results of the lathing tests are shown in FIGS. 4 and 5, of which FIG. 4 is a graph showing the major flank abrasion VB in μm and FIG. 5 shows the undeformed chip thickness each as a function of the work time in minutes. In these figures, the curves 1a to 1e and the curves 2a to 2e are for the results obtained without and with, respectively, application of the ultrasonic vibrations and the curves 1a and 2a, curves 1b and 2b, curves 1c and 2c, curves 1d and 2d and curves 1e and 2e are for the results obtained with the chips of which the round-bottom grooves had an inclination angle θ of 0°, 15°, 30°, 45° and 60° , respectively.

While the flank abrasion VB is usually increased as the work time is extended, it is understood from FIG. 4 that the increase in VB is relatively small under application of the ultrasonic vibrations along with a relatively small dependency on the inclination angle θ. With regard to the undeformed chip thickness h, it is understood from FIG. 5 that the values of h are generally large under application of the ultrasonic vibrations to give a higher working efficiency than in the works without application of the ultrasonic vibrations.

### EXAMPLE 2

A machining test similar to that in Example 1 was undertaken by using a workpiece of a quench-hardened high-chromium cast iron in place of the workpiece of sintered zirconia ceramic in Example 1. The lathing conditions included: an ultrasonic frequency of 20 kHz; feed rate of 0.05 mm/revolution; cutting speed of 10 m/minute; inclination angle θ of the round-bottom groove in the chip of 30°; and cutting depth of 0.25 mm, the other parameters being the same as in Example 1.

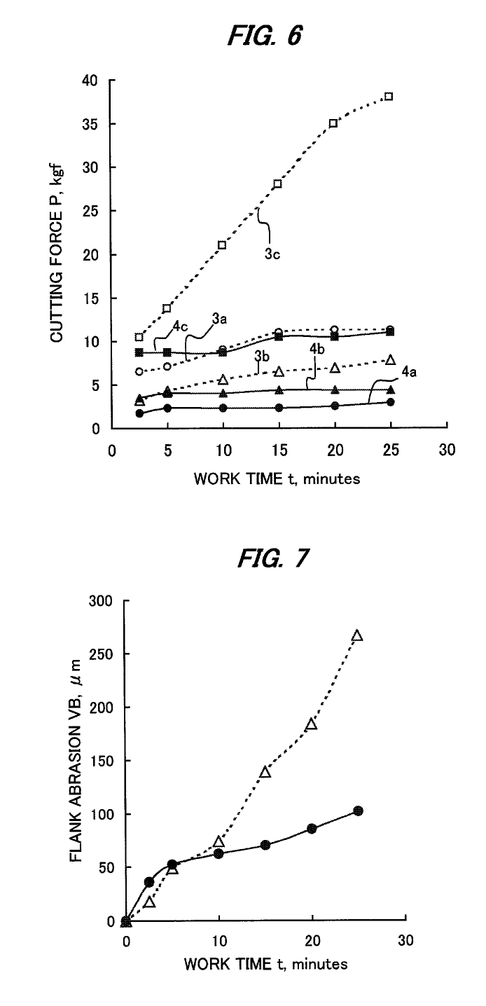

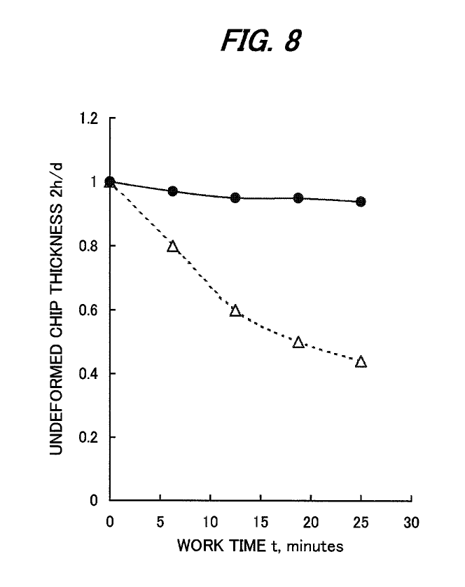

The results of the lathing test are shown in FIGS. 6, 7 and 8, of which FIG. 6 is a graph showing the cutting force P in kgf, FIG. 7 is a graph showing the flank abrasion VB in μm and FIG. 8 is a graph showing the undeformed chip thickness 2h/d each as a function of the work time t in minutes. In these graphs, the solid-line curves are for the tests with application of the ultrasonic vibrations and the broken-line curves are for the tests without application of the ultrasonic vibrations. In FIG. 6, the cutting force is recorded in three component forces including the major cutting force shown by the curves 3a and 4a, feed force shown by the curves 3b and 4b and thrust force shown by the curves 3c and 4c.

As is understood from FIG. 6, each of the component forces of the cutting force, i.e. major cutting force, feed force and thrust force, is remarkably decreased by the application of the ultrasonic vibrations as compared with the tests without application of the ultrasonic vibrations. FIG. 7 indicates that the flank abrasion VB can be greatly decreased by the application of the ultrasonic vibrations leading to a so much extension of the durability life of the cutting tool. In addition, FIG. 8 indicates that the undeformed chip thickness h can be increased by the application of the ultrasonic vibrations contributing to the improvements in the working efficiency and working accuracy.

What is claimed is:

1. A machining tool for machining of a workpiece made from a difficult-to-machine material which comprises:
a cutting chip having a conically pointed end made from a cemented metal carbide and having a round-bottom groove running with inclination of 15° to 60° relative to the cutting face of the chip, the round-bottom groove having a radius of curvature in the range from 0.2 mm to 0.5 mm.

2. A method for machining of a workpiece of a difficult-to-machine material by the use of a machining tool with a cutting chip made from a cemented metal carbide and having a conically pointed end which comprises the steps of:
(a) putting the end point of the cutting chip of the machining tool as defined in claim 1 at the workpiece to effect cutting of the workpiece; and
(b) applying ultrasonic vibrations to the cutting chip in the direction of cutting.

3. The method as claimed in claim 2 in which the frequency of the ultrasonic vibrations is in the range from 20 kHz to 75 kHz.
